(19) United States
(12) Patent Application Publication
(10) Pub. No.: US 2023/0048136 A1
(43) Pub. Date: Feb. 16, 2023

(54) High-voltage Energy Module and its Preparation Method thereof

(71) Applicants: Weirundong WANG, Macao (MO); TingLanKangCheng New Energy Technology Co., Ltd., Maco (MO)

(72) Inventor: Weirundong WANG, Macao (MO)

(73) Assignees: Weirundong WANG; TingLanKangCheng New Energy Technology Co., Ltd.

(21) Appl. No.: 17/488,047

(22) Filed: Sep. 28, 2021

(30) Foreign Application Priority Data
Aug. 13, 2021 (CN) 202110930947.2

(51) Int. Cl. H01M 50/231; H01M 50/227; H01M 50/224; H01M 50/536

(52) U.S. Cl. CPC H01M 50/231; H01M 50/227; H01M 50/224; H01M 50/536

(57) ABSTRACT

A high-voltage energy module includes an insulating shell, a plurality of bare cells connected in series inside the insulating shell, one positive terminal and one negative terminal. The minimum number of bare cells is two. Each bare cell is formed by a positive film, a negative film and a separating film sandwiched between the positive film and the negative film. The positive film, the negative film and the separating film form a one-piece structure by conductive resin glue. Each two bare cells are connected by an insulating layer of flame-retardant composite insulating materials. The positive film is electrically connected to a positive conductive lug. The negative film is electrically connected to a negative conductive lug. There is only one electrical connection in the positive film, and there is only one electrical connection in the negative film.

### BACKGROUND OF THE PRESENT INVENTION

### Field of Invention

The present invention relates to manufacture of lithium-ion battery, and more particularly relates to structure and auxiliary materials of lithium-ion battery and a preparation method of lithium-ion battery system.

### Description of Related Arts

At present, lithium-ion batteries are manufactured by first using monomerization of liquid injection encapsulation of naked battery to prepare into low voltage capacity units—single battery cells, and then dividing the capacities of and grouping the single battery cells into series and parallel alignment to form high-voltage battery packs. The process is complicated, the efficiency is low, and the consumption of parts and materials is large. The lithium-ion batteries are used as energy aggregates, so poor safety performance, low energy density, high manufacturing cost and short life have become common problems of lithium-ion batteries. In order to solve the problem of poor safety performance of lithium-ion batteries, a large number of research in methods relating to reinforcement, sealing, flame-retardant, and thermal management of the outer packaging are developed, thus resulting in complicated process, large amount of auxiliary consumables, and high production cost.

The principle of battery charging and discharging is the electrochemical reaction of battery materials. When the input and output current increases, the electrochemical reaction will intensify, and safety issues are introduced. If all the energy is released in a short time, explosion may be resulted. Therefore, it is impossible and unrealistic to use outer packaging reinforcement, sealing, flame retardancy, and thermal management as the means to improve safety performance and reduce manufacturing costs. Also, the applicable scope of lithium-ion batteries will be reduced dramatically.

### SUMMARY OF THE PRESENT INVENTION

An object of the present invention is to provide a high-voltage energy module and a manufacturing method thereof so that structure simplification, safety improvement and manufacturing cost reduction can be achieved to facilitate industrial mass production.

In order to Additional advantages and features of the invention will become apparent from the description which follows, and may be realized by means of the instrumentalities and combinations particular point out in the appended claims.

According to the present invention, the foregoing and other objects and advantages are attained by a high-voltage energy module, which comprises:

at least two bare cells immersed in electrolyte solution, namely, N₁, N₂, N₃, Nₘ (m≥2),

wherein the bare cell Np (1≤p≤m−1) and the bare cell Nₚ₊₁ are integrally connected by an insulating layer,

each bare cell comprises a positive film, a negative film, and a separating film sandwiched between the positive film and the negative film, which are folded, stacked or rolled together to form a one-piece structure;

the positive film of the bare cell Nx (1≤x≤m) is connected to the positive conductive lug, the negative film of the bare cell Ny (1≤y≤m, and y≠x) is connected to the negative conductive lug; and

the positive film of the bare cell Nq (1≤q≤m, q≠x, q≠y) is electrically connected to the negative film of another bare cell Nr (1≤r≤m, r≠q, r≠y), and the negative film of the bare cell Nq is electrically connected to the positive film of the bare cell Ns (1≤s≤m, s≠q, s≠x).

In addition, the high-voltage energy module further comprises an insulating shell having a receiving cavity therein, wherein the bare cells N₁−Nm are stacked in order inside the insulating shell.

Preferably, the upper surface of the bare cell N₁ and the insulating shell are integrally connected together through the insulating layer, and the lower surface of the bare cell Nₘ, and the insulating shell are integrally connected together through the insulating layer. A positive conductive lug is connected to the positive film of the bare cell N₁, a negative conductive lug is connected to the negative film of the bare cell Nₘ.

The positive film of each of the corresponding bare cells N₂−Nm are electrically connected to the negative film of the immediate adjacent bare cells N₁−Nm−1 so that all the bare cells N₁−Nm are connected integrally in series to form a one-piece structure.

Preferably, the upper surface of the bare cell Nₘ, and the insulating shell are integrally connected together through the insulating layer, and the lower surface of the bare cell N₁ and the insulating shell are integrally connected together through the insulating layer. A positive conductive lug is connected to the positive film of the bare cell Nₘ a negative conductive lug is connected to the negative film of the bare cell N₁.

The positive film of each of the corresponding bare cells N₁−Nm−1 are electrically connected to the negative film of the immediate adjacent bare cells N₂−Nm so that all the bare cells N₁−Nm are connected integrally in series to form a one-piece structure.

Preferably, the insulating layer has a frame-retardant composite insulating double-sided tape structure with an elastic deformation of 3-75%, and a dielectric strength equal or greater than 500V.

The electrical connection is the connection between the corresponding positive and negative films by a conductive connecting piece.

The conductive connecting piece, the positive conductive lug and the negative conductive lug are all good electronic conductors.

The positive conductive lug or the negative conductive lug is connected to the corresponding positive or negative film by conductive resin glue to form an integral one-piece structure. The conductive connecting piece is connected to the corresponding positive or negative film by conductive resin glue to form an integral one-piece structure. Alternatively, ultrasonic welding, or rivets can also be used as the connection means for forming the one-piece structure.

Preferably, the insulating shell includes an inner layer of the insulating tape that closely adheres and wraps all bare cells and an outer layer of the aluminum foil tape that closely adheres and wraps the insulating tape. The inner layer of the insulating tape is a structure made of PP, PE or PET, and the outer layer of the aluminum foil tape is a structure of aluminum foil.

The present invention further comprises a preparation method of the high-voltage energy module, which comprises the steps of:

S1: preparing m number of bare cells N₁−Nₘ(m≥2), wherein each bare cell is prepared by stacking positive film, negative film and separating film sandwiched between the positive film and the negative film sequentially;

S2: sequentially stacking and integrally connecting the bare cells Np(1≤p≤m−1) and the bare cell Nₚ₊₁ by using an insulating layer;

S3: for all bare cells except Nx and Ny, the positive film of each bare cell is connected to a negative film of another bare cell except Ny, and there is only one electrical connection relationship in the positive film of each bare cell; for all bare cells except Nx and Ny, the negative film of each bare cell is connected to a positive film of another bare cell except Nx, and there is only one electrical connection relationship in the negative film of each bare cell, thereby the bare cells are connected in series;

S4: the positive film of the bare cell Nₓ to a positive conductive lug, and the negative film of the bare cell N_{y} to a negative conductive lug;

S5: Soaking the stacked bare cells in electrolyte solution, after the positive conductive lug and the negative conductive lug are connected to a high-voltage charging and discharging cabinet, activating the positive film and the negative film of the bare cells to obtain the high-voltage energy module.

The present invention has the following advantageous effects:

(1) According to the high-voltage energy modules of the present invention, bare cells are arranged next to each other and are connected in series and in sequence, and are encapsulated by an insulating shell. The structure is simple, and the amount of parts and consumables is small, which reduces the manufacturing cost. By setting the flame-retardant composite insulating double-sided tape structure between two adjacent bare cells, the burning phenomenon of the high-voltage energy module is effectively avoided. The insulating shell adopts a double-layer structure with an inner layer of the insulating tape and an outer layer of the aluminum foil tape, which effectively prevent the occurrence of the explosion of the high-voltage energy module, thus providing high safety level, and suitable for large-scale industrial production and wide ranges of applications.

(2) According to the present invention, the manufacturing method of the high-voltage energy modules is simple in production process, and is suitable for large-scale industrial production and wide ranges of applications.

According to the present invention, the manufacturing method is suitable for preparing high-voltage energy modules, and the prepared high-voltage energy modules are suitable for new energy vehicles and various chemical energy storages.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 a schematic cross-sectional structure diagram of a high-voltage energy module manufactured according to Embodiment 1 of the present invention.

FIG. 2 is a schematic diagram of the structure of each bare cell in FIG. 1.

In the figures: 1: Insulating shell; 2: Positive conductive lug; 3: Insulating layer; 41: positive film; 42: Separating film; 43: negative film; 5: Conductive connecting piece; 6: negative conductive lug

### DETAILED DESCRIPTION OF THE PREFERRED EMBODIMENT

### Preferred Embodiment 1: High-Voltage Energy Module and its Preparation Method Thereof

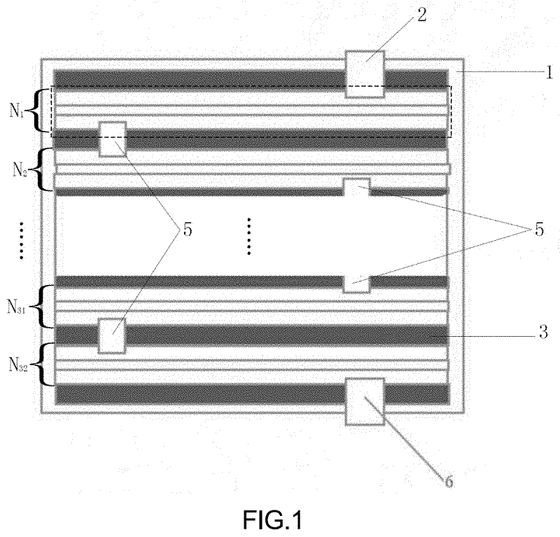

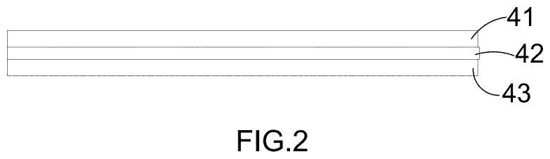

Referring to FIG. 1 and FIG. 2 of the drawings, a high-voltage energy module according to the preferred embodiment 1 of the present invention comprises: an insulating shell 1, and a plurality of bare cells inside the insulating shell 1. According to this embodiment, the high-voltage energy module includes thirty-two bare cells inside the insulating shell 1. The thirty-two bare cells are immersed in lithium hexafluorophosphate electrolyte and are stacked on top of each other in order inside the insulating shell 1, which are sequentially denoted as N₁, N₂ . . . N₃₁, N₃₂ from top to bottom. The twenty-eight bare cells N₃-N₃₀ between N₂ and N₃₁ are omitted in FIG. 1.

It is worth mentioning that the minimum number of bare cells is two. The actual number of bare cells is based on the actual energy requirements. The number of bare cells is 32 according to this specific embodiment.

The bare cell Np (1≤p≤31) and the bare cell Nₚ₊₁ are integrally connected by an insulating layer 3. The upper surface of the bare cell N₁ and the insulating shell 1 are integrally connected together through the insulating layer 3, and the lower surface of the bare cell N₃₂ and the insulating shell 1 are integrally connected together through the insulating layer 3. As shown in FIG. 2 of the drawings, each bare cell N is an integrated one-piece structure, which includes a positive film 41, a negative film 43, and a separating film 42 sandwiched between the positive film 41 and the negative film 43.

It is worth mentioning that the bare cell has a one-piece structure. Preferably, the positive film 41, the negative film 43 and the separating film 42 has an elongated sheet structure. The separating film 42 are sandwiched and connected between the positive film 41 and the negative film 43 to form a composite film. The composite film with three film layers 41, 43, 42 are then rolled, cut, or folded to a desired dimension to form one bare cell of a particular shape for ease of manufacturing.

The positive film 41 of the bare cell N₁ is bonded with a positive conductive lug 2 by PVDF mixed with 3% carbon nanotube conductive resin glue, and the negative film 43 of the bare cell N₃₂ is bonded with a negative conductive lug 6 by PVDF mixed with 3% carbon nanotube conductive resin glue. Each positive film 41 of the corresponding bare cells N₂ to N₃₂ is electrically connected to the negative film 43 of the corresponding adjacent bare cells N₁ to N₃₁ through a conductive connecting piece 5 so that all the bare cells N₁-N₃₂ are integrally connected in series. The conductive connecting piece 5 is integrally bonded to the corresponding positive film 41 or the corresponding negative film 43 by PVDF mixed with 3% carbon nanotube conductive resin glue to form a one-piece structure. Both the positive conductive lug 2 and the negative conductive lug 6 lead to the outside of the insulating shell 1, serving as the positive and negative terminals of the high-voltage energy module.

According to this embodiment, the bare cells N₁ to N₃₂ are lithium iron phosphate bare cells. The positive film 41 is 375 mm×4700 mm, 224 Wh/m² lithium iron phosphate material; the negative film 43 is 378 mm×4700 mm, 228 Wh/m² artificial graphite material; the separating film 42 is a polypropylene material having a dimension of 381 mm×4700 mm with a thickness of 12 μm. Each of the bare cells N₁— N₃₂ has a voltage of 3.2V and a capacity of 100 Ah.

According to this embodiment, the insulating layer 3 utilizes a SBR flame-retardant composite insulating double-sided tape structure. Each insulating layer 3 has a thickness of 0.6 mm, an elastic deformation of 50%, and a dielectric strength of 1000V.

The insulating shell 1 comprises an inner layer of insulating tape that closely adheres and wraps all bare cells and an outer layer of aluminum foil tape that closely adheres and wraps the insulating tape. The inner layer of the insulating tape is a structure made of PP, PE or PET, and the outer layer of the aluminum foil tape is a structure of aluminum foil. The conductive connecting piece 5, the positive conductive lug 2, the negative conductive lug 6 are all electronic conductive composite nickel sheet with a thickness of 0.3 mm.

According to this preferred embodiment, the preparation method of the high-voltage energy module comprises the steps of:

S1: stacking positive film 41, negative film 43 and separating film 42 sandwiched between the positive film 41 and the negative film 43 sequentially to form one bare cell, repeating the above steps to form thirty-two bare cells N₁−N₃₂;

S2: sequentially stacking and connecting all the bare cells N₁−N₃₂ from top to bottom, wherein a SBR flame-retardant composite insulating double-sided tape is utilized for bonding between the bare cell Np (1≤p≤31) and the bare cell Nₚ₊₁;

S3: for bare cells N₂−N₃₁, electrically connecting the positive film 41 of each bare cell to the negative film 43 of a corresponding adjacently positioned bare cell by a conductive connecting piece 5, wherein there is only one electrical connection relationship between the positive film 41 of each bare cell; and electrically connecting the negative film 43 of each bare cell to the positive film 41 of a corresponding adjacently positioned bare cell by a conductive connecting piece 5, wherein there is only one electrical connection relationship between the negative film 43 of each bare cell, thereby connecting the bare cells in series are realized;

wherein the conductive connecting piece 5 is integrally bonded to the corresponding positive film 41 or the corresponding negative film 43 by PVDF mixed with 3% carbon nanotube conductive resin glue;

S4: Bonding the positive film 41 of the bare cell N₁ to a positive conductive lug 2 by PVDF mixed with 3% carbon nanotube conductive resin glue, and bonding the negative film 43 of the bare cell N₃₂ to a negative conductive lug 6 by PVDF mixed with 3% carbon nanotube conductive resin glue;

S5: Soaking the 32 stacked bare cells in lithium hexafluorophosphate electrolyte, using the inner layer of insulating tape to tightly wrap the 32 bare cells, and then using the outer layer of aluminum foil tape to tightly wrap the inner layer of the insulating tape to complete the packaging of the thirty-two stacked bare cells, wherein both the positive conductive lug 2 and the negative conductive lug 6 are led to the outside of the insulating shell 1, after the positive conductive lug 2 and the negative conductive lug 6 are connected to a 200V/200A high-voltage charging and discharging cabinet, the positive film 41 and the negative film 43 of the bare cell are activated to obtain the high-voltage energy module.

The prepared high-voltage energy module has a voltage of 102.4V, a capacity of 100 Ah, and an energy density of 187 Wh/kg. At room temperature 1C charge and discharge cycle 3500 times, the state of charge (SOC) maintains 85% capacity. The manufacturing cost is 450 yuan/kWh. No explosion phenomenon occurs when using standard needle penetration test.

With the exception of this embodiment, an alternative of the structure of each bare cell can also be formed by stacking or winding the positive film 41, the negative film 43, and the separating film 42 sandwiched between the positive film 41 and the negative film 43 of the corresponding bare cell is also within the scope of the present invention.

The relative position relationship of the bare cells N₁— N₃₂ can also be distributed from bottom to top. The purpose is to save space and convenient operation when connecting in series. Therefore, as long as the bare cells N₁— N₃₂ are distributed in order next to each other, they should fall within the protection scope of the present invention.

With the exception of this embodiment, the series structure between all bare cells can adopt the following connection relationship:

The positive film 41 of the bare cell Nx (1≤x≤32) is connected to the positive conductive lug 2, the negative film 43 of the bare cell Ny (1≤y≤32, and y≠x) is connected to the negative conductive lug 6. In all the bare cells except the bare cell Nx and the bare cell Ny, the positive film 41 of each bare cell is electrically connected to the negative film 43 of another bare cell except the bare cell Ny, and there is only one electrical connection relationship between the positive film 41 of each bare cell. In all the bare cells except the bare cell Nx and the bare cell Ny, the negative film 43 of each bare cell is electrically connected to the positive film 41 of another bare cell except the bare cell Nx, and there is only one electrical connection relationship between the negative film 43 of each bare cell.

In addition, the connection relationship can also be used in the series structure between all bare cells: the positive film 41 of the bare cell N₃₂ is connected to the positive conductive lug 2, the negative film 43 of the bare cell N₁ is connected to the negative conductive lug 6. All the bare cells except for the bare cell N32 are electrically connected to each other through the positive film 41 and the negative film 43 of the adjacent bare cell below to form a series structure. The series connection structure of the bare cells as described above is also within the protection scope of the present invention.

The inner layer of the insulating tape can also be made of PE or PET, which should fall within the protection scope of the present invention.

The connection relationship between the conductive connecting piece and the corresponding positive film or between the conductive connecting piece and the corresponding negative film can also be welded and integrated by ultrasonic welding, or riveted together by rivets to form a one-piece structure. The connection relationship between the above-mentioned conductive connecting piece and the corresponding positive film or the corresponding negative film should be within the protection scope of the present invention.

It is worth mentioning that the terms of: top, bottom, upper are used according to the orientation of the drawings figures for ease of understanding only and is not intended to be limiting.

### Embodiment 2: High-Voltage Energy Module and its Preparation Method Thereof

This embodiment is basically the same as the above embodiment 1 except that:

the insulating layer 3 has a SBR composite insulating double-sided tape structure with an elastic deformation of 3%, and a dielectric strength of 500V. The prepared high-voltage energy module has a voltage of 102.4V, a capacity of 100 Ah, and an energy density of 187 Wh/kg. At room temperature 1C charging and discharging cycle 3500 times, the state of charge (SOC) maintains 85% capacity. The manufacturing cost is 450 yuan/kWh. There is a slight volume deformation and no breakdown during the charging and discharging cycle of the high-voltage energy module, indicating that in the high-voltage energy module, the 3% elastic deformation of the SBR flame-retardant composite insulating double-sided tape is the minimum critical value, and the dielectric strength of 500V is suitable or excessive.

### Embodiment 3: High-Voltage Energy Module and its Preparation Method Thereof

This embodiment is basically the same as the embodiment 1 except that:

the insulating layer 3 has a SBR composite insulating double-sided tape structure with an elastic deformation of 75%, and a dielectric strength of 500V. The prepared high-voltage energy module has a voltage of 102.4V, a capacity of 100 Ah, and an energy density of 187 Wh/kg. At room temperature 1C charge and discharge cycle 3500 times, the state of charge (SOC) maintains 85% capacity. The manufacturing cost is 450 yuan/kWh. There is no volume deformation, breakdown, fire or explosion during the charging and discharging cycle of the high-voltage energy module, indicating that in the high-voltage energy module, the 75% elastic deformation of the SBR flame-retardant composite insulating double-sided tape and the dielectric strength of 500V is suitable or excessive.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A high-voltage energy module, comprising:
at least two bare cells, namely, N₁, N₂, N₃, . . . Nₘ (m≥2), wherein the bare cells are immersed in electrolyte solution, and
an insulating layer integrally connected between the bare cell Np (1≤p≤m−1) and the bare cell Nₚ₊₁ to form a one-piece structure;
wherein each bare cell is a one-piece structure formed by folding, stacking or rolling a positive film, a negative film, and a separating film sandwiched between the positive film and the negative film;
the positive film of the bare cell Nx (1≤x≤m) is connected to a positive conductive lug, the negative film of the bare cell Ny (1≤y≤m, and y≠x) is connected to a negative conductive lug; and
the positive film of the bare cell Nq (1≤q≤m, q≠x, q≠y) is electrically connected to the negative film of another bare cell Nr (1≤r≤m, r≠q, r≠y), and the negative film of the bare cell Nq is electrically connected to the positive film of the bare cell Ns (1≤s≤m, s≠q, s≠x).

2. The high-voltage energy module according to claim 1, further comprising: an insulating shell having a receiving cavity therein, wherein the bare cells N₁− Nm are stacked in order inside the insulating shell.

3. The high-voltage energy module according to claim 2, wherein an upper surface of the bare cell N₁ and the insulating shell are integrally connected together through the insulating layer, and the lower surface of the bare cell Nₘ and the insulating shell are integrally connected together through the insulating layer, the positive conductive lug is connected to the positive film of the bare cell N₁, and the negative conductive lug is connected to the negative film of the bare cell Nₘ, the positive film of each of the corresponding bare cells N₂−Nm are electrically connected to the negative film of the immediately adjacent bare cells N₁−Nm−1 so that all the bare cells N₁−Nm are connected integrally and are connected in series to form a one-piece structure.

4. The high-voltage energy module according to claim 2, wherein the upper surface of the bare cell Nₘ and the insulating shell are integrally connected together through the insulating layer, and the lower surface of the bare cell N₁ and the insulating shell are integrally connected together through the insulating layer, the positive conductive lug is connected to the positive film of the bare cell Nₘ, and the negative conductive lug is connected to the negative film of the bare cell N₁, the positive film of each of the corresponding bare cells N₁−Nm−1 are electrically connected to the negative film of the immediately adjacent bare cells N₂−Nm so that all the bare cells N₁−Nm are connected integrally and are connected in series to form a one-piece structure.

5. The high-voltage energy module according to claim 1, wherein the insulating layer has a frame-retardant composite insulating double-sided tape structure with an elastic deformation of 3-75%, and a dielectric strength equal or greater than 500V.

6. The high-voltage energy module according to claim 3, wherein the insulating layer has a frame-retardant composite insulating double-sided tape structure with an elastic deformation of 3-75%, and a dielectric strength equal or greater than 500V.

7. The high-voltage energy module according to claim 4, wherein the insulating layer has a frame-retardant composite insulating double-sided tape structure with an elastic deformation of 3-75%, and a dielectric strength equal or greater than 500V.

8. The high-voltage energy module according to claim 1, wherein the positive film of the bare cell Nq (1≤q≤m, q≠x, q≠y) is electrically connected to the negative film of another bare cell Nr (1≤r≤m, r≠q, r≠y) by a conductive connecting piece, and the negative film of the bare cell Nq is electrically connected to the positive film of the bare cell Ns (1≤s≤m, s≠q, s≠x) by a conductive connecting piece;
the conductive connecting piece, the positive conductive lug and the negative conductive lug are good electronic conductors;
the positive conductive lug or the negative conductive lug is connected to the corresponding positive or negative film respectively by conductive resin glue to form an integral one-piece structure, the conductive connecting piece is connected to the corresponding positive or negative film by conductive resin glue to form an integral one-piece structure.

9. The high-voltage energy module according to claim 4, wherein the positive film of the bare cell Nq (1≤q≤m, q≠x, q≠y) is electrically connected to the negative film of another bare cell Nr (1≤r≤m, r≠q, r≠y) by a conductive connecting piece, and the negative film of the bare cell Nq is electrically connected to the positive film of the bare cell Ns (1≤s≤m, s≠q, s≠x) by a conductive connecting piece;
the conductive connecting piece, the positive conductive lug and the negative conductive lug are good electronic conductors;
the positive conductive lug or the negative conductive lug is connected to the corresponding positive or negative film respectively by conductive resin glue to form an integral one-piece structure, the conductive connecting piece is connected to the corresponding positive or negative film by conductive resin glue to form an integral one-piece structure.

10. The high-voltage energy module according to claim 4, wherein the positive film of the bare cell Nq (1≤q≤m, q≠x, q≠y) is electrically connected to the negative film of another bare cell Nr (1≤r≤m, r≠q, r≠y) by a conductive connecting piece, and the negative film of the bare cell Nq is electrically connected to the positive film of the bare cell Ns (1≤s≤m, s≠q, s≠x) by a conductive connecting piece;
the conductive connecting piece, the positive conductive lug and the negative conductive lug are good electronic conductors;
the positive conductive lug or the negative conductive lug is connected to the corresponding positive or negative film respectively by ultrasonic welding or rivet to form an integral one-piece structure, the conductive connecting piece is connected to the corresponding positive or negative film by ultrasonic welding or rivet to form an integral one-piece structure.

11. The high-voltage energy module according to claim 2, wherein the insulating shell comprises an inner layer of an insulating tape that closely adheres and wraps all bare cells and an outer layer of an aluminum foil tape that closely adheres and wraps the insulating tape of the inner layer, wherein the inner layer of the insulating tape is a structure made of PP, PE or PET, and the outer layer of the aluminum foil tape is a structure of aluminum foil.

12. The high-voltage energy module according to claim 4, wherein the insulating shell comprises an inner layer of an insulating tape that closely adheres and wraps all bare cells and an outer layer of an aluminum foil tape that closely adheres and wraps the insulating tape of the inner layer, wherein the inner layer of the insulating tape is a structure made of PP, PE or PET, and the outer layer of the aluminum foil tape is a structure of aluminum foil.

13. The high-voltage energy module according to claim 7, wherein the insulating shell comprises an inner layer of an insulating tape that closely adheres and wraps all bare cells and an outer layer of an aluminum foil tape that closely adheres and wraps the insulating tape of the inner layer, wherein the inner layer of the insulating tape is a structure made of PP, PE or PET, and the outer layer of the aluminum foil tape is a structure of aluminum foil.

14. The high-voltage energy module according to claim 9, wherein the insulating shell comprises an inner layer of an insulating tape that closely adheres and wraps all bare cells and an outer layer of an aluminum foil tape that closely adheres and wraps the insulating tape of the inner layer, wherein the inner layer of the insulating tape is a structure made of PP, PE or PET, and the outer layer of the aluminum foil tape is a structure of aluminum foil.

15. The high-voltage energy module according to claim 10, wherein the insulating shell comprises an inner layer of an insulating tape that closely adheres and wraps all bare cells and an outer layer of an aluminum foil tape that closely adheres and wraps the insulating tape of the inner layer, wherein the inner layer of the insulating tape is a structure made of PP, PE or PET, and the outer layer of the aluminum foil tape is a structure of aluminum foil.

16. The high-voltage energy module according to claim 1, is manufactured by a preparation method of the high-voltage energy module, which comprises the steps of:
S1: preparing m number of bare cells N₁−Nₘ(m≥2), wherein each bare cell is prepared by stacking positive film, negative film and separating film sandwiched between the positive film and the negative film sequentially;
S2: sequentially stacking and integrally connecting the bare cells Np (1≤p≤m−1) and the bare cell Nₚ₊₁ by using an insulating layer;
S3: for all bare cells except Nx and Ny, the positive film of each bare cell is connected to a negative film of another bare cell except Ny, and there is only one electrical connection relationship in the positive film of each bare cell; for all bare cells except Nx and Ny, the negative film of each bare cell is connected to a positive film of another bare cell except Nx, and there is only one electrical connection relationship in the negative film of each bare cell, thereby the bare cells are connected in series;
S4: the positive film of the bare cell Nₓ is connected to a positive conductive lug, and the negative film of the bare cell N_{y} is connected to a negative conductive lug;
S5: Soaking the stacked bare cells in electrolyte solution, after the positive conductive lug and the negative conductive lug are connected to a high-voltage charging and discharging cabinet, activating the positive film and the negative film of the bare cells to obtain the high-voltage energy module.

17. The high-voltage energy module according to claim 4, is manufactured by a preparation method of the high-voltage energy module, which comprises the steps of:
S1: preparing m number of bare cells N₁−Nₘ, (m≥2), wherein each bare cell is prepared by stacking positive film, negative film and separating film sandwiched between the positive film and the negative film sequentially;
S2: sequentially stacking and integrally connecting the bare cells Np (1≤p≤m−1) and the bare cell Nₚ₊₁ by using an insulating layer;
S3: for all bare cells except Nx and Ny, the positive film of each bare cell is connected to a negative film of another bare cell except Ny, and there is only one electrical connection relationship in the positive film of each bare cell; for all bare cells except Nx and Ny, the negative film of each bare cell is connected to a positive film of another bare cell except Nx, and there is only one electrical connection relationship in the negative film of each bare cell, thereby the bare cells are connected in series;
S4: the positive film of the bare cell Nₓ is connected to a positive conductive lug, and the negative film of the bare cell N_{y} is connected to a negative conductive lug;
S5: Soaking the stacked bare cells in electrolyte solution, after the positive conductive lug and the negative conductive lug are connected to a high-voltage charging and discharging cabinet, activating the positive film and the negative film of the bare cells to obtain the high-voltage energy module.

18. The high-voltage energy module according to claim 7, is manufactured by a preparation method of the high-voltage energy module, which comprises the steps of:
S1: preparing m number of bare cells N₁−Nₘ, (m≥2), wherein each bare cell is prepared by stacking positive film, negative film and separating film sandwiched between the positive film and the negative film sequentially;
S2: sequentially stacking and integrally connecting the bare cells Np (1≤p≤m−1) and the bare cell Nₚ₊₁ by using an insulating layer;
S3: for all bare cells except Nx and Ny, the positive film of each bare cell is connected to a negative film of another bare cell except Ny, and there is only one electrical connection relationship in the positive film of each bare cell; for all bare cells except Nx and Ny, the negative film of each bare cell is connected to a positive film of another bare cell except Nx, and there is only one electrical connection relationship in the negative film of each bare cell, thereby the bare cells are connected in series;
S4: the positive film of the bare cell Nₓ is connected to a positive conductive lug, and the negative film of the bare cell N_{y} is connected to a negative conductive lug;
S5: Soaking the stacked bare cells in electrolyte solution, after the positive conductive lug and the negative conductive lug are connected to a high-voltage charging and discharging cabinet, activating the positive film and the negative film of the bare cells to obtain the high-voltage energy module.

19. The high-voltage energy module according to claim 9, is manufactured by a preparation method of the high-voltage energy module, which comprises the steps of:
S1: preparing m number of bare cells N₁−Nₘ, (m≥2), wherein each bare cell is prepared by stacking positive film, negative film and separating film sandwiched between the positive film and the negative film sequentially;
S2: sequentially stacking and integrally connecting the bare cells Np (1≤p≤m−1) and the bare cell Nₚ₊₁ by using an insulating layer;
S3: for all bare cells except Nx and Ny, the positive film of each bare cell is connected to a negative film of another bare cell except Ny, and there is only one electrical connection relationship in the positive film of each bare cell; for all bare cells except Nx and Ny, the negative film of each bare cell is connected to a positive film of another bare cell except Nx, and there is only one electrical connection relationship in the negative film of each bare cell, thereby the bare cells are connected in series;
S4: the positive film of the bare cell Nₓ is connected to a positive conductive lug, and the negative film of the bare cell N_{y} is connected to a negative conductive lug;
S5: Soaking the stacked bare cells in electrolyte solution, after the positive conductive lug and the negative conductive lug are connected to a high-voltage charging and discharging cabinet, activating the positive film and the negative film of the bare cells to obtain the high-voltage energy module.

20. The high-voltage energy module according to claim 14, is manufactured by a preparation method of the high-voltage energy module, which comprises the steps of:
S1: preparing m number of bare cells N₁−Nₘ, (m≥2), wherein each bare cell is prepared by stacking positive film, negative film and separating film sandwiched between the positive film and the negative film sequentially;
S2: sequentially stacking and integrally connecting the bare cells Np (1≤p≤m−1) and the bare cell Nₚ₊₁ by using an insulating layer;
S3: for all bare cells except Nx and Ny, the positive film of each bare cell is connected to a negative film of another bare cell except Ny, and there is only one electrical connection relationship in the positive film of each bare cell; for all bare cells except Nx and Ny, the negative film of each bare cell is connected to a positive film of another bare cell except Nx, and there is only one electrical connection relationship in the negative film of each bare cell, thereby the bare cells are connected in series;
S4: the positive film of the bare cell Nₓ is connected to a positive conductive lug, and the negative film of the bare cell N_{y} is connected to a negative conductive lug;
S5: Soaking the stacked bare cells in electrolyte solution, after the positive conductive lug and the negative conductive lug are connected to a high-voltage charging and discharging cabinet, activating the positive film and the negative film of the bare cells to obtain the high-voltage energy module.
